(19) United States
(12) Patent Application Publication
(10) Pub. No.: US 2015/0201657 A1
(43) Pub. Date: Jul. 23, 2015

(54) Method for the Manufacture of Larger Particle Forms of Low Sodium Salts

(71) Applicant: Grain Processing Corporation, Muscatine, IA (US)

(72) Inventor: Sarjit Johal, Iowa City, IA (US)

(21) Appl. No.: 14/590,704

(22) Filed: Jan. 6, 2015

Related U.S. Application Data
(60) Provisional application No. 61/930,361, filed on Jan. 22, 2014.

(51) Int. Cl. A23L 1/237

(52) U.S. Cl. CPC A23L 1/237; A23V 2002/00

(57) ABSTRACT

A method for producing a low sodium salt composition, including aspects for producing fraction(s) of a selectable particle size is provided. Millable particles can be produced. The method does not require agglomeration to obtain larger-sized solids. The composition generally includes salt, such as sodium chloride, and one or more crystallization interrupters. The composition is in the form of amorphous particles, optionally in combination with other ingredients.

### FIELD OF THE INVENTION

This application relates to methods for preparing salt compositions, and to related compositions. In some aspects a method is provided for production of multiple recoverable fractions of particle sizes varying from fine powder to coarse, larger particles in a single production cycle.

### BACKGROUND OF THE INVENTION

Many health organizations and professionals suggest that excessive sodium use may lead to or aggravate detrimental health conditions such as hypertension and arterial disease. This has led to an increasing interest in reducing dietary sodium consumption.

Some prior attempts to lower dietary sodium can be broadly grouped into three general categories. These include multi-component ingredient blends that include varying amounts of sodium chloride; physiochemical modifications to evaporated salts; and salt substitutes such as non-sodium and botanical flavorants. These approaches may also be used in combination.

Salt blends and substitutes employing some of these concepts have been commercialized to varying degrees of success. For example, a number of low- or no-sodium products use potassium chloride. Potassium chloride sometimes is perceived as being bitter or having an off-flavor, and accordingly is sometimes used with masking agents. Other attempts have employed mixtures of ingredients to modify taste as well as the overall perception so they more closely resemble the physical characteristics of salt, such as particle size, bulk density and the general feel and appearance of salt. Most models based on this practice employ flavor neutral or inert fillers and carriers such as starches, maltodextrins, fibers, waxes and other materials both soluble and insoluble.

Further, the use of sodium salt alternatives has been studied. These alternatives include other salts such as potassium, magnesium, calcium and combinations thereof, and in other cases flavorings derived from plant, microbial, animal, mineral or synthetic sources that mimic, enhance or otherwise promote and deliver the taste and perception of table salt. While useful in select applications, many of these replacement products impart off flavors or are simply too weak to provide the expected flavor. Dilution is a particular challenge in systems that attempt to lower sodium in the absence of mimetic agents.

There are other examples of physical modifications or chemical additions to alter the taste and perception of table salt in order to achieve low sodium compositions that offer the taste experience of common table salt. Many of these methodologies and practices, however, have not yielded the expected results.

Copending application Ser. No. 13/370,802 (entitled “Salt Composition”) teaches a method for preparing salt particles. In one form, the salt particles are spray-dried to yield salt particles of a size on the order of 20 microns. To prepare larger particles, the spray-dried particles may be agglomerated. In some forms, it has been found that the agglomerated particles are sometimes more friable than desired. Further, in certain applications, such as with crackers and pretzels, it may be desirable to have salt particles that are larger and more closely resemble salt particles traditionally used on these products.

### SUMMARY

Disclosed are methods for production of salt particles and associated compositions, products, and methods of use. In some embodiments, the disclosed method provides for producing different sized particulate forms of principally non-crystalline (amorphous) salt, including low sodium salt, that differ in physical attributes such as particle size but otherwise mimic available crystalline salt products for commercial applications. In some cases, the method provides for production of larger sized non-crystalline salt particles, on the order of 2000 microns or larger in some cases, without requiring separate agglomeration steps. The larger sized particles are useful in some embodiments, for example as pretzel salt, or can be fragmented as desired to yield sodium salt particles of a relatively homogeneous size pre-selected within a range of less than about 75 microns to upwards of about 2,000 microns.

The method may involve preparing a salt composition from an aqueous solution that includes a salt, which is typically sodium chloride, and a crystallization interrupter. The aqueous solution is then dried, such as through conduction drying, to cause the crystallization interrupter and sodium chloride to form particles wherein some (and preferably a majority) of the sodium chloride in the particles is present in amorphous (non-crystalline) form. Conduction drying can be accomplished through a variety of methods, such as drum drying or roller drying. In such cases, the resulting dried product is formed as a sheet, which can be milled to form particles. This method can be used to form larger particles without the need for agglomerating smaller particles, such as would generally result from a spray-drying process.

In other embodiments, the method provides a seasoning composition, and in other embodiments, a method for imparting a salty flavor to food. The seasoning composition generally includes a salt composition as described above in combination with another seasoning agent. The method for imparting salty flavor generally contemplates adding a salt composition as described above to food or during the manufacture of food.

### BRIEF DESCRIPTION OF THE DRAWINGS

FIGS. 1-6 are photomicrographs of different resolutions of a drum-dried, principally amorphous salt particle.

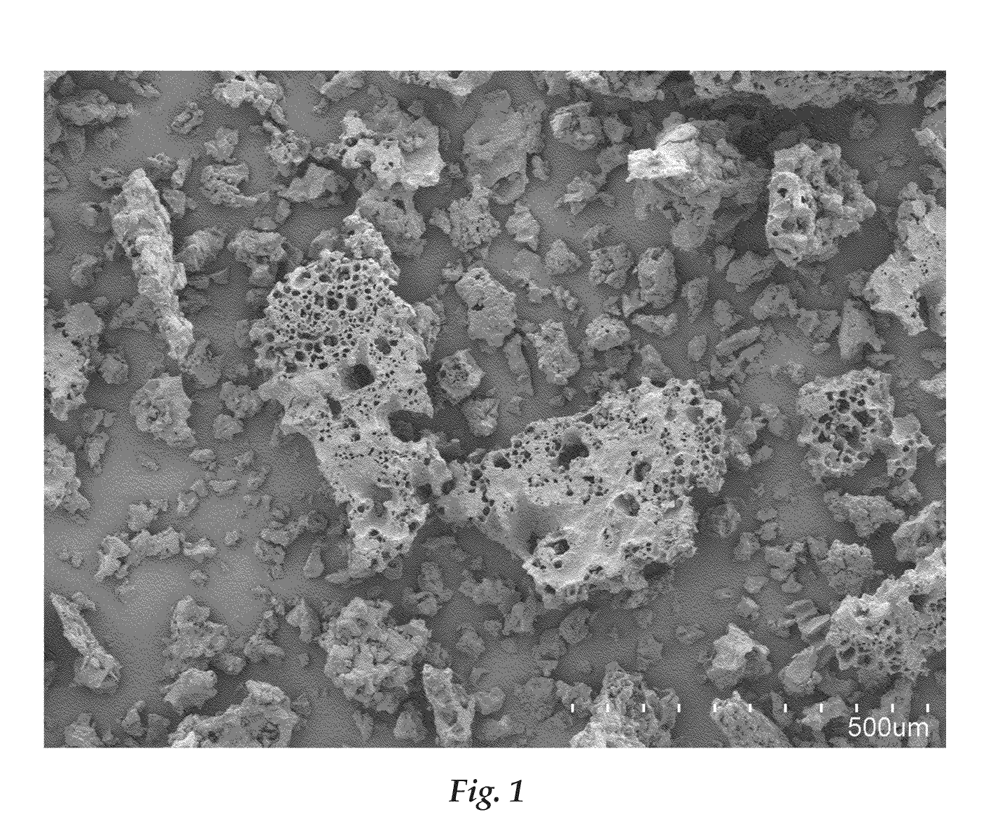

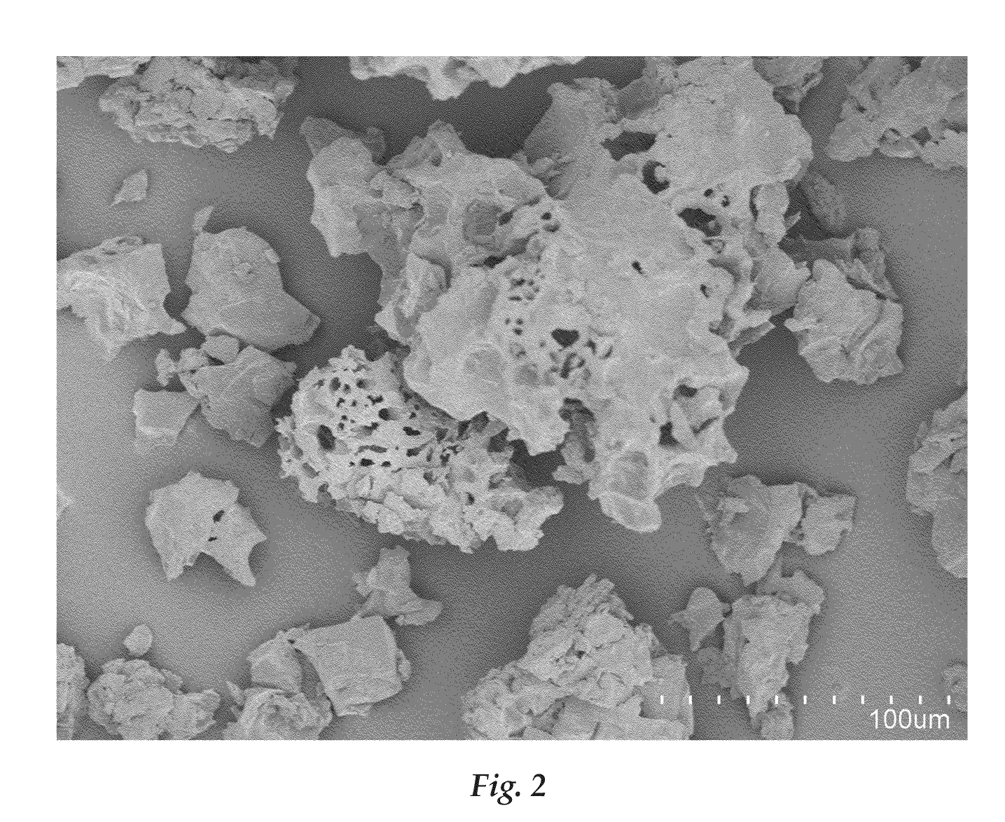

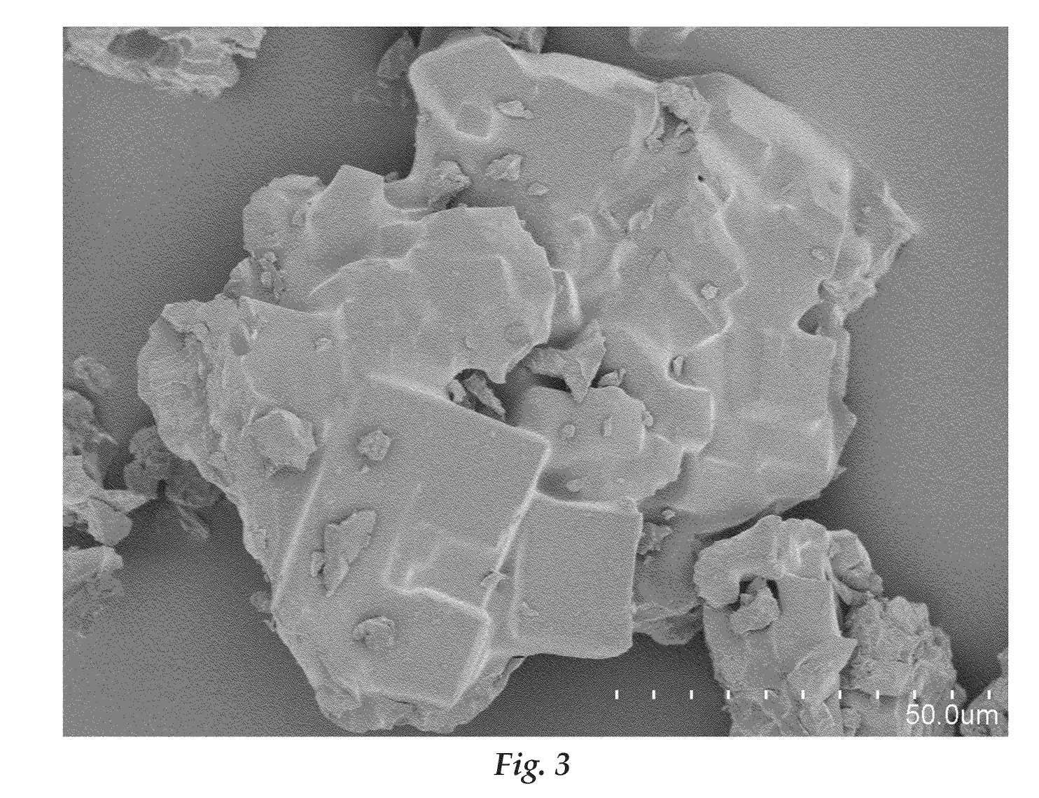

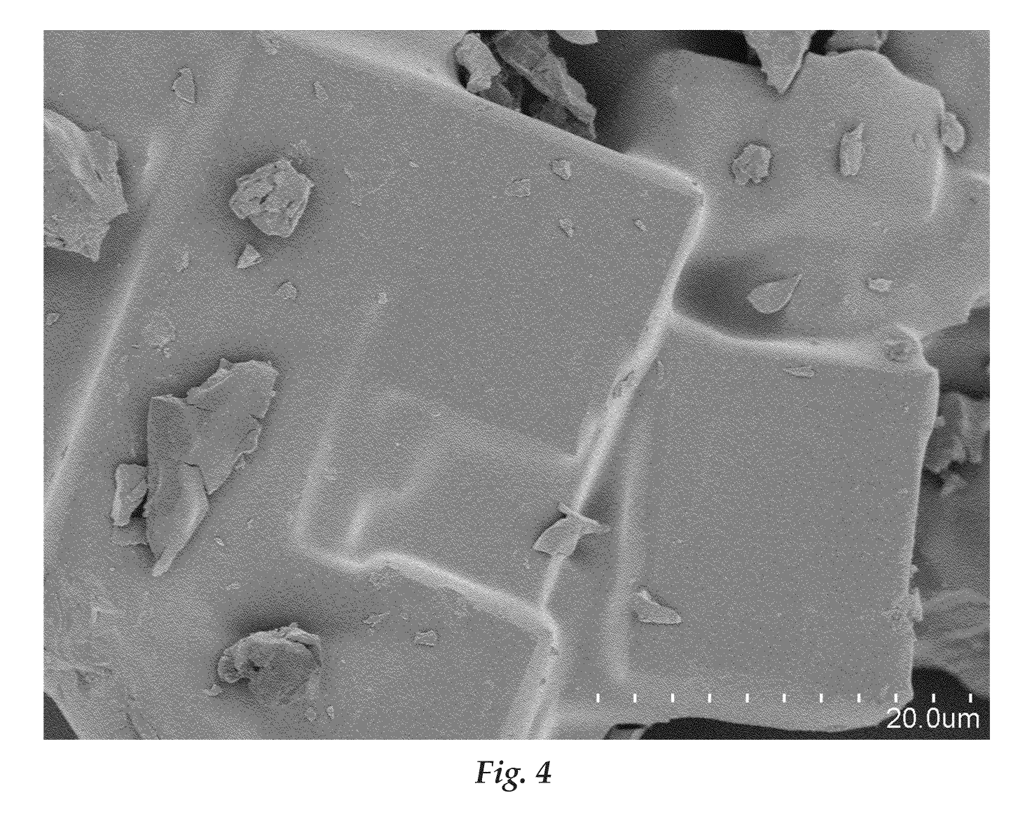

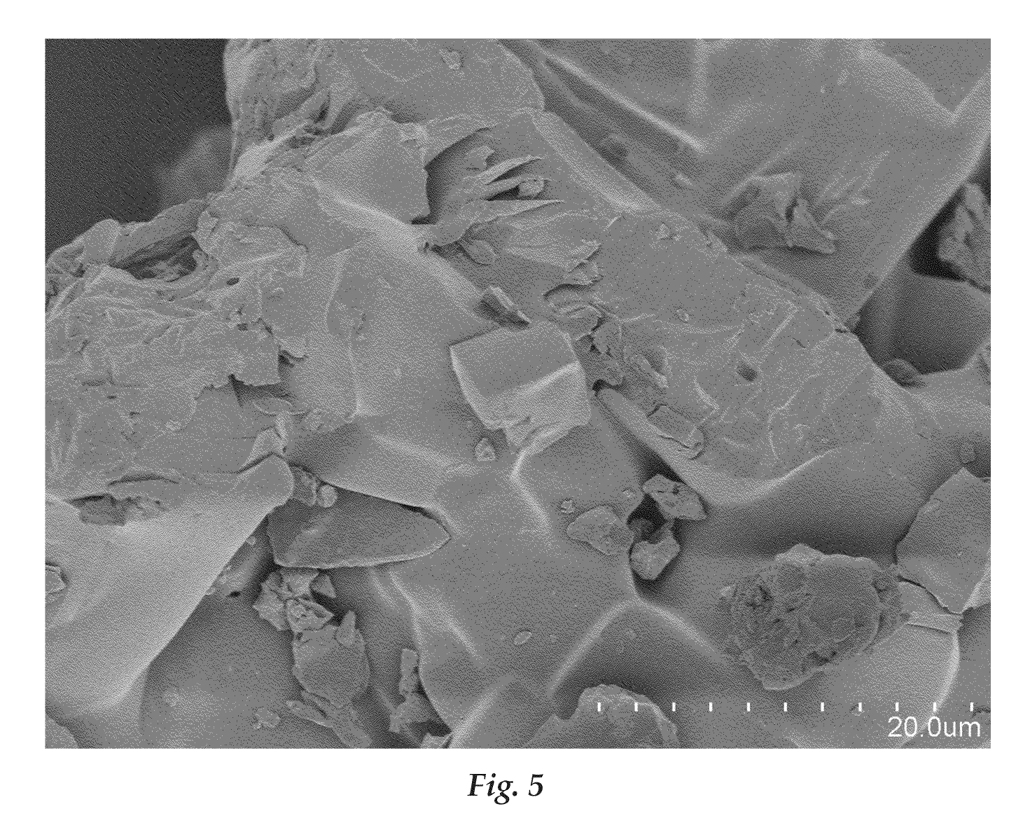

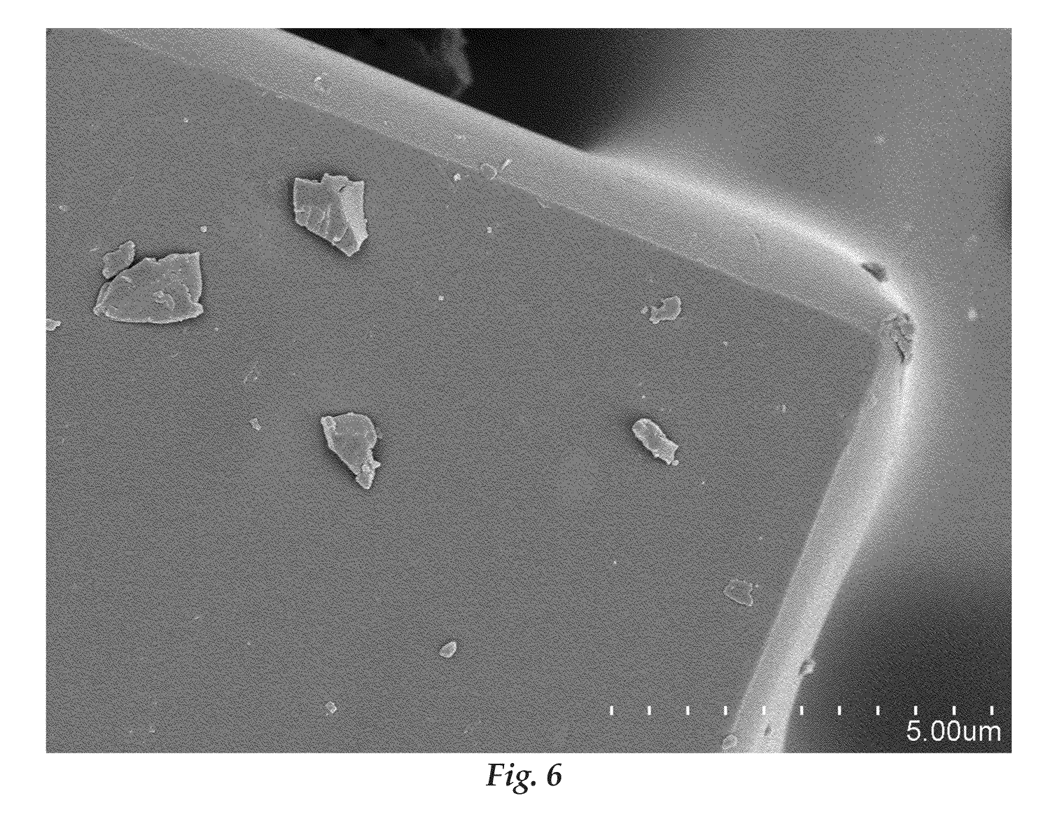

### DETAILED DESCRIPTION

A present method can produce amorphous particles that incorporate a salt, typically a sodium chloride salt, with a crystallization interrupter. In many embodiments, the particle contains about 15% to about 80% sodium chloride, and includes a crystallization interrupter selected from among polymers and oligomers. In some forms, the particle contains about 20%, about 30%, about 40%, about 50%, about 60%, or about 70% sodium chloride.

Salt perception can be attained at a lower overall sodium chloride concentration than realized in conventional table salt by providing a salt particle that is more soluble than crystalline salt. This is accomplished by providing a salt particle where at least some of the salt, and preferably a majority of the salt, is present in an amorphous form. Such a salt particle may be prepared by interrupting the formation of salt crystals from an aqueous solution with a crystallization interrupter. The particles are suitable for consumption, particularly for those who wish to reduce sodium intake.

Generally, a method for preparing the salt particles includes providing an aqueous solution of salt and crystallization interrupter, along with any additional desired materials. The salt, such as sodium chloride, and crystallization interrupter may be combined with water, each individually, in combination or sequentially. If desired, the solution may be agitated, such as through aggressive agitation, until all of the solids have been completely dissolved. In one form, the solution is agitated for 30 to 60 minutes. It should be understood that the solution may be agitated for other durations, as necessary to dissolve the solids. The solution can, if needed or desired, be heated to facilitate solubilization of the ingredients. The salt and other ingredients, such as a maltodextrin interrupter, can also be added individually to the liquid, that is, without prior dry blending. The dissolved solution is then conduction dried to provide a dried material. Resulting product that is not used or is otherwise undesired can be recycled. Further, the process can be a continuous or batch process, with or without recycling. The resulting product can be used as is, milled, screened, and/or combined with further materials.

As mentioned above, once the solution is dissolved, the solution is conduction dried to produce dried particles, typically having a moisture content of less than 4%. The particles may also be dried to less than 3%, less than 2% and preferably less than 1%. It should be understood that the conduction drying step described herein contemplates a non-naturally occurring conduction drying (sometimes referred to as artificial conduction drying) using a heated drying surface on which the solution is applied/deposited. Such a drying step can include any suitable procedure, such as drying using a drier having one or more cylinders, internally heated, and rotating, upon the outer surface of which the solution to be dried is applied/deposited. Examples of preferred classes of such driers having internally heated cylinders are roller driers for roller drying or drum driers for drum drying.

Surprisingly, an acceptable product is obtained using such dryers without having to remove water as quickly as in a spray drying procedure, and without scorching or discoloration. The physical attributes such as particle form, distribution of particle sizes, bulk density, solubility of the dried product may be influenced by the conductive drying technique employed, and the system or equipment employed in recovery or post-production processing.

Unlike spray drying, conduction drying can directly produce larger-sized particles that can, in principle, be tailored to meet targeted average particles sizes. For example, after drum drying or roller drying, and after the product recovery step, particle size fractions, ranging, for example, from large irregularly shaped particles (such as flakes) having sizes greater than 2,000 microns, larger but mid-sized irregularly shaped particles (such as so-called small flakes) having sizes in a range of 850 microns up to about 2,000 microns, smaller sized irregularly shaped particles (such as so-called very fine small flakes) having sizes in a range of about 250 microns up to about 850 microns, or combinations of any thereof are obtainable. Other particle size distributions and fractions are obtainable. Being able to easily produce larger-sized product particles translates into greater manufacturing flexibility and offers the prospect of reduced costs for the manufacturer compared to agglomerating spray dried particles (20-50 microns) into larger particles. In principle, smaller sized particles comparably sized to those obtained from spray drying may also be obtainable in an aspect of a present method.

In a conduction drying step performed using a roller or drum dryer, a low solids composition may be deposited on the outer surface of a heated drum or roller, e.g., on the outer surface of a rotating, internally heated cylinder. The low solids composition is typically a solution that is deposited by spraying, pouring or dipping onto the outer surface of a heated rotating surface of a roller or drum. The composition adheres to the outer surface, usually for the greater part of a rotation, during which time the drying takes place. In one form, the composition adheres to the outer surface for about 40 to about 70 seconds. However, it should be understood that the residence time on the outer surface may vary depending on a number of factors including, but not limited to, the composition, the temperature, the size of the roller, the ambient conditions and the like. As the surface rotates, the dried product can be scraped off, which is typically done using a stationary blade. The blade is usually positioned relative to the cylinder (roller or drum) so the dried product is scraped off before a full rotation of the roller or drum is completed.

A low solids solution is generally one having a % solids content below a solids content at which nucleation occurs during processing. In general, an exemplary low solids solution herein has a solids content less than about 30%. For example, good results have been obtained at a solids concentration of about 25 to 28%. Other solids content are also contemplated including, but no limited to, 10%, 15%, 20%, and the like.

In practice, in the conduction drying step, it is desirable to achieve stable conditions during drying. By controlling the suitable stable conditions, such as rotation speed and the temperature of the conduction drying surface (e.g., a cylinder, such as a roller or drum), a dried product predominately comprised of dried product characterized as sheet-like or sheet shaped can be obtained. Variances from such stable conditions can be chosen to shift production towards larger fraction(s) comprised of smaller sized particles.

In principle, the conduction dried particles can have a moisture content of about 1 to about 4% and preferably 1.5 to 3%.

As demonstrated by the Examples, in another of its aspects, the recovery step following the drying step can affect the morphology and influence the size distribution of the product particles obtained. Following conduction drying, such as by roller or drum drying, recovery by certain mechanical techniques, such as using a trough with a screw conveyer, can be used to transport collected product that removed from the drier. Controlling the screw conveyer can enable larger-sized product sizes to be collected for subsequent processing or packaging. Recovery by other techniques, such as a pneumatic system with a cyclone blower, can be used. Pneumatic systems can shift the product size distribution towards more modest sizes than are typically obtained with a mechanical technique, such as a screw conveyer system. The pneumatic system can, in principle, even be used to shift the particle size distribution more closely to the sizes obtained by the spray drying method.

In one of its aspects, a method can produce a sheet-like or sheet-shaped product from which sufficiently large sized particles are obtained to avoid a need to agglomerate smaller sized products to obtain larger sized food grade salt products. In one form, a method can be used to produce predominately large or mid-sized particles, for example, that can be fragmented to obtain smaller-sized particles, or even powdered particles. The present method can therefore be characterized in one of its aspects as a way to produce extremely large sized, large sized, and/or mid-sized products and the like without requiring a manufacturer to agglomerate small sized (or fine) salt particles or powdered salt particles. Fragmenting a sheet-like product or a sheet-shaped product can, of course, be practiced to separate and obtain other fractions of particle sizes having smaller average particle sizes. The larger sized products and particles obtained by a present process can be fragmented, such as by milling or grinding, to produce smaller sized particles. The particles of a selected sieve size can be collected following fragmentation. The latter collection may be deemed fractionating a fragmented salt composition into relatively homogeneously-sized (sieved) particle fractions.

It will be appreciated that a present process provides flexibility to manufacture various commercially attractive products. Thus, in an aspect of a present method, various commercial salt products are obtainable by fragmenting product recovered after the drying step, such as milling or grinding, to a selected particle size followed, if needed or desired, by sieving. Commercial salt products are commonly associated with different particle sizes.

While the particle sizes (sieve sizes) may differ as between different sources, some sources of pretzel grade salt characterize the salt particles as having from −20 mesh to +35 mesh (U.S. standard sieve), whereas some characterize so-called shaker grade salt particles as having a wider particle distribution and may be characterized as having from −40 mesh to +60 mesh particles (U.S. standard sieve). Some suppliers of popcorn grade salt characterize the salt particles as −170 mesh particles (U.S. standard sieve). Table salt is typically comprised of particles about 200-300 microns in size. These and other commercial products are obtainable in an aspect of the present method involving a selected fragmentation to a target particle size coupled, optionally, with a selected sieving step.

Fragmenting can include milling as discussed above, which can be conducted with a suitable milling apparatus. Suitable milling apparatus includes a hammer mill. In production runs where larger quantities of milled product or larger-sized milled product is intended, it will be appreciated that a hammer mill can be operated in a closed system with separate larger sized (surface area) screens than commonly provided on conventional milling apparatus. Other milling or grinding apparatus can be selected depending on the needs or preferences of the manufacturer.

A present method can thus include sieving the product produced, whether those recovered or produced after fragmenting, to fractionate the particles into more distinct, and homogeneous, particle size fractions. For example, if larger sized particles are the desired, a fraction(s) of particles smaller than the desired larger sized particles can be separated, collected and recycled for use in preparing a solution to be re-deposited on the heated roller or drum, or separated, packaged and sold separately. Or, for example, the entire output or portion thereof of a present method can be fragmented, such as by milling or grinding, to generate finer sized salt particles, such as salt particles comparable to those obtained by the conventional spray drying process, if that is the desired product.

It will be appreciated that in an aspect of the present method that product fraction(s) comprised of relatively homogeneous-sized particles are obtainable. It will be further appreciated that such fractions can be selected in advance, such as by suitably selecting the appropriate fragmenting and, if desired, sieving operations/steps. For example, with such kinds of selection, such as by suitable milling and sieve selection, selective production of essentially homogeneous-sized particles suitable for pretzel grade, shaker grade, or table salt grade and so on are obtainable according to an aspect of the present method.

It will be appreciated by those skilled in the art that as a result of inevitable breakage and the like, there may be portions of material produced of unwanted size. These portions can be collected and recycled for rehydrating and drying and so on.

In one of its aspects, a method therefore comprises providing a low solids aqueous solution in which the dissolved solids include up to about 70% to 80% sodium chloride and a crystallization interrupter selected from among polymers and oligomers; and conduction drying the aqueous solution, preferably by roller or drum drying, to cause the polymer and sodium chloride to form dried product, where at least substantially all of the sodium chloride is present in an amorphous form, recovering said product, and fragmenting said recovered product to obtain particles (fractions) of a selected size suitable for consumption. The dissolved solids preferably comprise less than 80% sodium chloride, but in any case the dissolved solids preferably contain sodium chloride in an amount less than a self-nucleating amount.

In its various aspects, the method can be operated in almost a continuous fashion, depending on the capacity of the conduction drying apparatus and the solution available for drying. In another aspect, a method can be practiced almost-batch wise, such as to permit changing to a different solution composition, changing the recovery system, and/or changing any aspect of a fragmentation system, to mention examples. In the last mentioned regard, changing the fragmentation system includes changing the milling/grinding to produce a different sized product, to mention an example.

While it is not intended to limit the invention to a particular theory of operation, it is believed that a crystallization interrupter will interact with salt in solution to inhibit the formation of salt crystals upon drying. The crystallization interrupter is theorized to interact with one or more of the ions in solution and to thereby interrupt the recombination of the ions when the composition is dried. When dried, the particles in the composition are composed of an amorphous particle, where some (and preferably a majority) of the salt is present in non-crystalline form. These particles typically are not composed of discrete crystallized salt particles on the surface of a non-salty carrier, as in some approaches. In some embodiments, substantially all of the salt is present in amorphous form. Amorphous form is contemplated to be as determined using electron microscopy at 5 micron resolution.

By this approach, in many cases the solubility of the salt relative to native salt crystals will increase. It is believed that this increase in solubility leads to an improved salt sensation. In dietary applications, by increasing the salt perception, the total amount of sodium chloride consumed may be reduced.

The salt particles obtainable in accordance with aspects of the present method exhibit favorable solvation characteristics upon wetting. In some forms, the material exhibits rapid dissolution and dispersion in low-moisture environments, and also exhibits adhesion to moistened food surfaces. Additionally, the salt composition can be further processed in various ways to produce different forms capable of delivering a broader array of sensory perceptions of salt.

Given the desire to decrease dietary sodium content, the method, in some forms, contemplates providing particles of sodium chloride salt, or mixtures of sodium chloride and other salts such as magnesium chloride, potassium chloride, calcium chloride, and other edible salts. In some aspects, the method contemplates other salts that do not include sodium chloride. When sodium chloride is used, the salt may be any standard sodium chloride material. The material may take the form of a dry salt or a brine as supplied.

Many materials may be used as crystallization interrupters. These include biologic oligomers and biopolymers generally, such as proteins, protein derivatives and starches or starch derivatives. Hydrolyzed starches are deemed particularly suitable, these including syrup solids and maltodextrins. Generally, the crystallization interrupter should be a non-ionic and non-crystallizing (or low-crystallizing) material(s) that is suitable for consumption. In some embodiments it is contemplated that low molecular weight carbohydrates or carbohydrate derivatives may be employed, although in many cases these will be not suitable if the carbohydrate itself crystallizes.

The crystallization interrupter may be selected from any number of different biopolymer and biooligomer materials and combinations of multiple materials. The biopolymer may be a hydrocolloid or other similar material. The biopolymer may also be a polysaccharide or oligosaccharide. For example, the biopolymer may be a starch or hydrolyzed starch or the like. The crystallization interrupter may include any oligosaccharide species, such as a malto-oligosaccharide, or mixture of a plurality of oligosaccharide species, and more generally to polysaccharide species and mixtures thereof. By “polysaccharide” and “oligosaccharide” are contemplated any species comprised of plural saccharide-units, whether linked by 1-4 linkages, 1-6 linkages, or otherwise.

By “malto-oligosaccharides” is contemplated any species comprising two or more saccharide units linked predominately via 1-4 linkages, and including maltodextrins and syrup solids. In some forms, at least 50 percent of the saccharide units in the malto-oligosaccharide are linked via 1-4 linkages. More preferably, at least about 60 percent of the saccharide units are linked via 1-4 linkages; even more preferably, at least about 80 percent of the saccharide units are so linked. The malto-oligosaccharides may include saccharide species having an odd DP value, and the profile may be partially defined by a saccharide species having a DP value of 1, for example, dextrose or sorbitol. The mixture further may include other saccharide species or other components.

Further, in some embodiments, at least a portion of the malto-oligosaccharides in the mixture have a DP value greater than 5. In some cases, at least one of the malto-oligosaccharide species in the mixture has a DP value of 8 or more. In one form, at least one species has a DP value of at least 10. For example, in one form, at least 80 percent of the malto-oligosaccharide species in the mixture have a DP greater than 5, and at least 60 percent may have a DP greater than 8. In another form, at least 80 percent of the malto-oligosaccharides species have a DP greater than 10. In some forms, the DP profile of the crystallization interrupter is such that at least 75 percent of the malto-oligosaccharides species in the mixture have a DP greater than 5 and at least 40 percent of the species in the mixture have a DP greater than 10. Such materials may be obtained conventionally, for example, by the partial hydrolysis of starch.

It is also contemplated that reduced malto-oligosaccharides may be employed as crystallization interrupters. Further teachings concerning malto-oligosaccharides generally, and reduced malto-oligosaccharides, can be found in U.S. Pat. Nos. 7,816,105; 7,728,125; 7,595,393; 7,405,293; 6,919,446; and 6,613,898; each to Barresi et al. and each assigned to Grain Processing Corporation of Muscatine, Iowa. One suitable material is MALTRIN® M100, a maltodextrin sold by Grain Processing Corporation of Muscatine, Iowa. Other materials deemed to be suitable include other malto-oligosaccharides sold as maltodextrins under the trademark MALTRIN® by Grain Processing Corporation of Muscatine, Iowa. The MALTRIN® maltodextrins are malto-oligosaccharide products, each product having a known typical DP profile. Suitable MALTRIN® maltodextrins include, for example, MALTRIN® M040, MALTRIN® M050, MALTRIN® M100, MALTRIN® M150, and MALTRIN® M180. Typical approximate DP profiles of the subject MALTRIN® maltodextrins are set forth in one or more of the foregoing patents.

Maltodextrins are safe, widely used food grade ingredients, and are ideally suited for use in a dietary reduced sodium salt mixture. Other favorable attributes include neutral taste and white coloration. Maltodextrins are manufactured from starches sourced from a number of starchy grains, including but not limited to corn, potato, wheat, tapioca and others.

The salt and crystallization interrupter may be present in any suitable amounts relative to one another. In some embodiments, the composition includes about 15% to about 80% sodium chloride. In others, the composition includes about 40% to about 70% sodium chloride. In yet other forms, the composition includes up to about 60% sodium chloride. Generally, in many cases sodium chloride is included in an amount of 15%, 20%, 25%, 30%, 35%, 40%, 45%, 50%, 55%, 65%, 70%, 75%, or 80%. The composition may include from about 15% to about 85% crystallization interrupter, such as about 20% to about 50% crystallization interrupter. The crystallization interrupter may be included in amounts of as 20%, 25%, 30%, 35%, 40%, 45%, 50%, 55%, 60%, 65%, 70%, 75%, 80%, or 85%. These amounts refer to weight percentages relative to the total weight of salt and crystallization interrupter. When in aqueous solution, the solution may include any amount of water suitable to dissolve the salt and crystallization interrupter.

It is believed that the effects of the crystallization interrupter is dependent on the relative concentration of salt and crystallization interrupter in the aqueous solution, and also possibly on the conduction drying method and speed of drying. Where the salt is present at a ratio of 80:20 (salt:crystallization interrupter) or greater, the sodium chloride appears to initiate nucleation with at least some crystal growth. At these high salt ratios, when the solution is dried, the particles are still generally amorphous, though they do include some features indicative of initial crystal formation. Therefore, in this form, the structure appears to be a mosaic of different morphologies, including both amorphous features and initial crystal features.

As the ratio of salt to interrupter decreases, crystallization is significantly retarded and may cease altogether. When salt is present at a ratio of 60:40 salt:crystallization interrupter or lower, there appears to be very little, if any, crystalline character to the dried particulate structures obtainable. This suggests that sodium chloride crystal nucleation may be inhibited or that the aqueous solution lacks sufficient free sodium chloride to allow crystals to grow. This is consistent with a suggestion that the crystallization interrupter may be sequestering or otherwise making the sodium and chloride ions unavailable for bonding and subsequent crystal formation.

Regardless of the precise mechanism, it appears evident that the presence of crystallization interrupters, such as maltodextrin, in solution with salt strongly affects usual crystal formation and development. Consequently the structures (or interactions) formed in solution appear to suggest an association between the polysaccharide and ions. Subsequently, upon removal of water, the maltodextrin appears to be a nucleus for particle development with the sodium and chloride ion associated with the polymer while also interrupting crystal growth.

The interactions and paths to formation indicate the formation of mixed or hybrid structures when dried. In addition physicochemical characteristics, such as rapid dissociation when wetted, dispersal on the surface of semi moist foods, and low bulk density appear to distinguish the amorphous material from many known crystalline salt forms.

Generally, a majority of the salt in a product obtainable according to a present method is non-crystalline. In many cases, the amorphous composition is substantially non-crystalline, by which is contemplated 1% or less of observable salt crystalline structure. In another form, the composition has less than 5% crystallization. According to another form, the product has less than 10% crystallization. In yet another form, the product has less than 15% crystallization.

The sodium chloride and crystallization interrupter composition exhibits increased solubility when compared to sodium chloride in native form. The increased solubilization and subsequent availability of sodium appears to diminish the need to substantially increase the total quantity consumed. In other words, this faster dissolution and dispersion in solution permits a more rapid salt perception and a decreased total intake of sodium chloride.

In one form, the method may produce deliberately or as a recoverable salt, a co-product. In this regard, the co-product can be recycled as described elsewhere herein. In principle, the co-product can comprise a fraction comprised of smaller sized particles that be powders and/or have an average size that may be comparable to a spray dried product.

In principle, a co-product comprised of small particles may, if the manufacturer chooses, be agglomerated, instead of being recycled, or it may be milled to obtain a fraction comprised of more homogeneous sized particles. In principle, if agglomerated, the particles may provide the appearance of conventional table salt. For example, in one form, the agglomerated particles may have an average size larger than about 100 microns. Binders, including but not limited to, polysaccharides, gums, and starches including modified starches, may be used for agglomeration. By this approach, salt particles may be produced having generally the same appearance, texture, flowability and other physical characteristics as conventional table salt. However, it is more advantageous to mill the larger sized products obtainable according to an aspect of the present method to obtain smaller-sized products, instead of incurring the cost penalties associated with agglomeration.

Further, the reduced sodium salt mixture produced in a selected particle size can be combined with a fine crystalline salt such as flour salt to further modify the flavor, physicochemical properties and final sodium content as needed. In this regard, the microcrystalline sodium chloride may be coated on the surface of particles to provide an extended salt flavor profile, or, if economically attractive it can be agglomerated with the particles to be randomly dispersed within agglomerated particles. For example, the coating may consist of microcrystalline salt dusted on the surface or sprayed on the surface with a binder. In some embodiments, crystallized sodium chloride may be coated onto the amorphous particle to provide a two-phase system. For example, it is believed that the composition may be created to provide a two-phase delivery system, where there is an immediate release of sodium chloride from the non-crystalline combination with the biopolymer, followed by a delayed but extended salty flavor component from the added crystalline component.

A fragmented fraction can be treated other ways to enhance its properties for consumption. For example, a fragmented composition may also be treated and processed in a manner similar to standard table salt. For example, a composition obtainable by a present method could be iodized.

A fragmented fraction(s) comprised of desired particle sizes having an amorphous composition may be used in preparing a seasoning for food materials. In some embodiments, a salt composition of a selected particle size obtainable according to a present method can be added as a seasoning in the preparation or manufacture of food products. For example, the salt composition may be included within the food material and/or sprinkled on the outer surfaces of the food material.

In other aspects, a composition is provided in the form of a seasoning composition that includes the salt composition (such as in a desired particle size following fragmentation) and one or more other seasonings. Exemplary seasonings include allspice, alum powder, chile pepper, anise, arrowroot, basil, bay leaves, bell pepper, black pepper, caraway seed, cardamom, red pepper celery, chervil, chives, cilantro, cinnamon, cloves, coriander, cream of tartar, Creole seasoning, cumin, curries, dill, fennel, garlic, ginger, horseradish, juniper, lemon, lime, mace, marjoram, mesquite, mustard, nutmeg, onion, oregano, paprika, parsley, peppercorn, poppy seed, rosemary, sage, savory, sesame tarragon, thyme, turmeric, and any other suitable seasoning. Further, the composition may include other materials such as vitamins, minerals, fibers, oils and combinations thereof. Soluble flavorings such as yeast extracts, plant extracts, fermented ingredients and can also be included. The additional materials may be included to provide a desired flavor profile, appearance, or other desired characteristic. Any suitable amounts of such materials may be used.

### EXAMPLES

The non-limiting Examples illustrate aspects of a present method and advantages of a present method. The present method allows the manufacturer to make large, medium and/or small particle sizes, or mixtures thereof, or, an essentially uniform powdered product, depending on the desired end use of the salt product in one production run. The present method allows for the possibility of recycling products not meeting selected (or desired) product morphology or size, and also allows for re-working of large sized particles to produce particles of a desired size. The examples show the present method enables manufacture of large (larger) sized products without requiring agglomeration of smaller-sized products as seen with spray dried products. This provides a significant cost advantage. Ultimately, the present method allows for greater flexibility in the manufacture of salt compositions.

### Example 1

An aqueous solution (about 3 liters) having a 60% sodium chloride, 10% potassium chloride and 30% maltodextrin (MALTRIN® M100, Grain Processing Corporation) was prepared.

The ingredients were added sequentially in the order listed to water and each ingredient allowed to fully dissolve before adding the next item. After all additions the composition was allowed to mix with agitation for about an additional 30 minutes. The complete composition was clear with no apparent viscosity. The final aqueous solution (composition) had a solids content of about 25% (a calculated value).

The thus prepared solution was conduction dried using a small pilot scale, double drum dryer. The dryer was preheated to about 110° C. As the dryer drums were rotating, the solution was manually poured into the center of the rotating drums. This was performed very slowly and carefully. Initially only some of the material dried. After several mechanical and temperature adjustments, most of the liquid dried and freely released from the drums. Such adjustments may include changing the rate of liquid application, changing the drum speed, adjusting the temperature and the like.

Over the course of the run, visual inspection of the dried product showed that two product forms were produced, powder and flakes. It was observed that during periods of stable operation, for example, stable drum temperature, speed and material application the percentages of large flake form increased.

Adjusting the double drum dryer from the stable large-flake producing conditions shifted product production from predominately large-flakes to the powdered form. Such adjustments may include changing the rate of liquid application, changing the drum speed, adjusting the temperature and the like.

The large-flake product produced was recovered and analyzed. The dried product was white colored, edible and salty with no off-flavors.

The powdered product analyzed. This dried product was white colored, edible and salty with no off-flavors.

### Example 2

This example shows another form of a reduced sodium salt mixture being prepared into a dried product according to an aspect of the present invention.

Several hundred gallons of a 26% solids aqueous solution consisting of 60% sodium chloride, 10% potassium chloride and 30% maltodextrin (MALTRIN® M100, Grain Processing Corporation) was prepared as follows. Water was in a jacketed tank heated to about 30° C. Each component was added individually and allowed to mix for a few minutes before the next item was introduced. Following all of the additions, the complete solution was mixed for about an additional 20 minutes. After mixing each component as well as during the blending the whole composition, the solution was checked to verify that all of the components had completely solubilized. The thus prepared solution was visually checked and confirmed as a clear solution.

During the preparation of the mixture, a production scale conduction dryer (double drum dryer) was readied for operation. The double drum dryer was a commercial unit having an adjustable, multi-nozzle, overhead spray (or atomizer) system for application of the clear solution to the top of the drums. The spray pattern and rate of application was tested and adjusted for drying prior to introducing sample. The drums were heated so that drying temperatures in the range of 140-150° C. were employed. The clear solution was applied to the dryer drums.

The composition dried quickly and released cleanly from the cylinders (drums).

### Example 3

Two forms of dry product were recovered from a drum dryer trial. A composition was prepared as in Example 2. At the start of the dryer trial, the liquid dried as fine powder. However after about 10-15 minutes of operation, the product shifted predominately to a product characterized as a sheet or sheet-like. The dried product peeled off the drum as a sheet except at the ends of the drum where the powder continued to be prevalent.

Over the course of a 5 hour trial a smaller and smaller percentage of the material dried as a fine powder. Generally 70%-80% of the product was in the sheet form and the remainder powder. During the process, the sheeted product fell off the drum upon encountering the scraper. Little if any adhered to the drum surface.

As the product tumbled off of the drums it was collected in a trough that ran the entire outside length the both drums. The trough was equipped with a mechanical screw conveyance system to transport the material to the next process step. During transport away from the unit, the stainless steel screw conveyer fractured the sheet material to produce a heterogeneous mix of particles.

The unfractionated mixture was bagged in 50 lb polylined bags as is. Samples taken from several bags showed that the final moisture was approximately 1.2%.

Material from several of the bags was later manually screened into three fractions, DD-2A, DD-2B and DD-2C, using a pilot scale screener (Sweco brand screener), and compared to a dried product produced using a spray dryer instead of a conduction dryer. The data collected is summarized in Table 1.

TABLE 1

| | Spray Dried Product | DD-2A | Drum Dried DD-2C | |
|---|---|---|---|---|
| DD-2B | Spherical Granule | Large Flake | Small Flake | Very Small Flake |
| Morphology | Homogeneous | Irregular forms | Irregular forms | Fairly consistent forms |
| Particle Size | 130 micron (avg) | >2000 micron | >850 to <2000 | >250 to <850 |
| Loose Density | 30.0 | 28.4 | 27.4 | 33.6 |
| Packed Density | 35.9 | 33.6 | 30.3 | 33.2 |

### Example 4

In a trial run comparable to Example 2, the liquid composition was prepared and dried. Instead of bagging the unfractionated mixture of dried product particles or screening and bagging the product though, it was milled to obtain small sized particles using an in-line hammer mill and screened. The screened particles were collected. The resultant product was comprised of dried solid particles that were characterized as having a fine, uniform composition and were comparable in appearance and size to particles obtained from spray drying instead of conduction drying.

Table 2 summarizes general conditions in Examples 3 and 4 in a method for producing the dried low sodium salt compositions. It will be appreciated that for Example 4 the conditions pertain to producing the dried product before milling.

TABLE 2

| % Solids | 25-28% | |
|---|---|---|
| Starting Liquid Temperature | 25-27° | C. |
| Drying Temperature | 140-160° | C. |
| (Metric used to monitor/adjust temperature: | | |
| 70-80 psi steam used to heat drum) | | |
| Application Rate to Drum | 4-6 gal per min | |
| Drum Speed | 70-80 | Hz |
| (Metric monitored/adjust to control speed: | | |
| motor power) | | |
| Production Rate | 750-850 | lbs/hr |

With drum dryers, sometimes drum rotation speeds are apparently measured/reported in Hz even though it seems more reflective of the electric current to the motor driving drum rotation.

### Example 5

A dried product is produced in a manner similar to Example 2, except that as the sheet-like or sheet-shaped product is scraped and tumbles off of the drums, it is collected and transported in a pneumatic conveyer (with a cyclone blower) to the next processing step in a manufacturing process. After being collected and transported pneumatically, the product comprises mostly smaller sized dried solids as compared to the product obtained in Example 2. The product is mostly comprised of solids having an average particle size of less than 400 microns, in the range of about 300 microns to about 400 microns.

All references cited are hereby incorporated by reference in their entireties.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

What is claimed is:

1. A method comprising:
providing an aqueous solution that includes sodium chloride and a crystallization interrupter selected from among nonionic biopolymers and biooligomers; and
conduction drying the aqueous solution to cause the biopolymer and sodium chloride to form a dried product, where at least a majority of the sodium chloride is present in an amorphous form, and
recovering the dried product.

2. The method of claim 1, wherein said method further comprises fragmenting the recovered dried product to obtain particles of selected particle size(s).

3. The method of claim 2, wherein said fragmenting comprises milling the dried product to obtain at least one product fraction comprised of homogeneously sized particles.

4. The method of claim 2, wherein said fragmented particles are sieved.

5. The method of claim 2, wherein in the aqueous solution includes about 40% to about 80% sodium chloride.

6. The method of claim 1, wherein the aqueous solution includes up to 70% sodium chloride.

7. The method of claim 1, wherein upon drying, substantially all of the sodium chloride is present in amorphous form.

8. The method of claim 1, wherein the crystallization interrupter is selected from the group consisting of oligosaccharides, polysaccharides, proteins, protein derivatives and combinations thereof.

9. The method of claim 1, wherein the crystallization interrupter is a starch hydrolysate.

10. The method of claim 8, wherein the starch hydrolysate is maltodextrin.

11. A method or preparing a seasoning composition comprising providing the recovered dried product of claim 2 and adding at least one seasoning to the recovered dried product to form a seasoning composition.

12. The method of claim 2, further comprising the step of at least partially coating the fragmented dried particles with microcrystalline salt.

13. The method of claim 2, wherein said dried product comprised of sizes from about 250 microns to about 2,000 microns wherein a majority of the sodium chloride is present in amorphous form.

14. The method of claim 13, wherein the sodium chloride is present in an amount of about 40% to about 60%.

15. The method of claim 13, wherein the biopolymer is selected from the group consisting of polysaccharides, proteins, protein derivatives and combinations thereof.

16. The method of claim 15, wherein the crystallization interrupter is a starch hydrolysate.

17. The method of claim 15, wherein the starch hydrolysate is maltodextrin.

18. A method comprising:
providing a food product; and
adding a salt composition obtained according to claim 2.

19. A method comprising providing a low solids aqueous solution in which the dissolved solids include up to about 70% to 80% sodium chloride and a crystallization interrupter selected from among biopolymers and biooligomers; and conduction drying the aqueous solution by roller or drum drying to cause the biopolymer and sodium chloride to form dried product, where at least substantially all of the sodium chloride is present in an amorphous form, recovering said product, and fragmenting said recovered product to obtain particles of a selected size suitable for consumption.
